(19) United States
(12) Patent Application Publication
(10) Pub. No.: US 2015/0001125 A1
(43) Pub. Date: Jan. 1, 2015

(54) MEMBRANE AND SYSTEM FOR CONTROLLING AN OPENING OF THE MEMBRANE

(71) Applicant: Commissariat à l'énergie atomique et aux énergies alternatives, Paris (FR)

(72) Inventors: Laure Peris Y Saborit, Grenoble (FR); Alan Jost, Grenoble (FR); Damien Marechal, Echirolles (FR); Alexandre Paleologue, Bordeaux (FR)

(21) Appl. No.: 14/319,098

(22) Filed: Jun. 30, 2014

(30) Foreign Application Priority Data
Jun. 28, 2013 (FR) 1356338

(51) Int. Cl. A61J 1/03

(52) U.S. Cl. CPC A61J 1/035; A61J 2205/60
USPC 206/534

(57) ABSTRACT

A divisible membrane, comprising a plurality of row conductive tracks distributed in rows and a plurality of column conductive tracks distributed in columns. There are individual cells, the outline of each cell being at least partly delimited by one of said row tracks and one of said column tracks. Each individual cell comprising an electrical component, electrically connected between a row conductive track of a respective row and a column conductive track of a respective column.

### RELATED APPLICATIONS

Under 35 USC 119, this application claims the benefit of the priority date of French Patent Application FR 1356338, filed on Jun. 28, 2013, the contents of which are herein incorporated by reference.

### FIELD OF INVENTION

The invention relates to the tracking of medicine-taking among patients, and in particular the devices for controlling the regular taking of medicines.

### BACKGROUND

In order to facilitate the taking of a precise medicine at a given frequency, it is known practice to use blisters that have pockets arranged in rows and columns. The pockets enclose the medicines for a respective dose and are sealed by a divisible membrane. When a dose is taken, the patient opens the divisible membrane and absorbs the medicines which are contained therein. The breaking of the membrane provides a visual identification of the medicine doses that have been taken and the medicine doses that are remaining.

Strict compliance with the taking of medicines in accordance with a medical prescription is often problematical. In practice, the patient may forget to take his or her medications at the appropriate time. Furthermore, the practitioner who is following the patient has no effective means of knowing whether the medication is being followed satisfactorily by the patient. Thus, a significant number of patients have to be hospitalized following failure to comply with the prescribed medication schedule. For certain mental pathologies, the failure to comply with the medication can induce serious troubles in the behaviour of the patient. This can also lead the practitioner to increase the dosage or to change the medication on observing a lack of effectiveness which is in fact linked to a medicine-taking problem.

The document WO01/54646 describes a pill dispenser provided with alarm electronics and packaging. Conductive tracks are connected at their intersection on each membrane over a pocket. These conductive tracks are also connected to a microprocessor which detects the opening of the membrane over a pocket. The breaking of a membrane over a cell induces the breaking of conduction in the entire row and in the entire column over which these conductive tracks pass, then making it impossible to detect openings for the other pockets.

### SUMMARY

The invention aims to resolve one or more of these drawbacks. There is in particular a need for a device that makes it possible to effectively identify the access to a pocket, by means of a simple and inexpensive structure, even for a large number of medicine pockets.

The invention thus relates to a divisible membrane as defined in the attached claims.

The invention relates also to a system comprising a membrane as described previously and a reading device, as defined in the attached claims.

Other features and advantages of the invention will emerge more clearly from the following description, given by way of indication and in a nonlimiting manner, with reference to the attached drawings.

### BRIEF DESCRIPTION OF THE DRAWINGS

FIG. 1 is an electrical circuit diagram of a system for detecting the opening of a pocket in a package sealed by a membrane, according to one embodiment of the invention;

FIG. 2 is a cross-sectional view of a pocket of the sealed packaging;

FIG. 3 is an electrical circuit diagram of a first variant packaging membrane and of certain elements of an associated packaging reader;

FIG. 4 is an equivalent electrical circuit diagram upon a detection of opening of a sealed package according to the first variant;

FIG. 5 is a diagram illustrating the sensitivity and the consumption of a reader as a function of a resistance value;

FIG. 6 is an electrical circuit diagram of a second variant packaging and of certain elements of an associated packaging reader;

FIG. 7 illustrates a variant of divisible packaging for the implementation of the invention;

FIG. 8 illustrates an example of joining of split elements in columns, in the absence of certain columns.

### DETAILED DESCRIPTION

The object of the invention relates to a divisible membrane (or a film), intended to be applied to pockets, similar to cells, each pocket comprising, for example, a dose of medicine to be delivered.

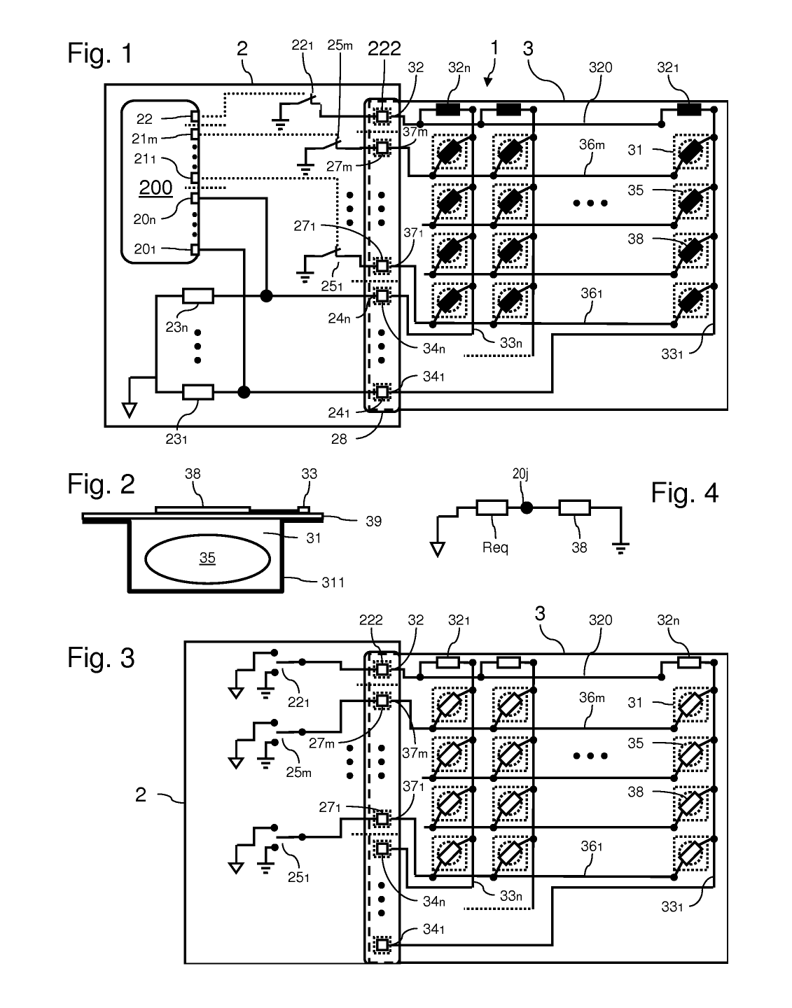

FIG. 1 is an electrical circuit diagram of a system 1 for detecting the opening of a pocket in a sealed package, implementing an embodiment of the invention. The system 1 comprises a package 3 and a reading device 2. In this embodiment, the package 3 and the reading device 2 are separable, such that the reading device 2 (potentially including costly electronic circuits) can be retained, whereas the package 3 can be disposable.

The package 3 comprises, in a manner known per se, a matrix of pockets 31, or cells, formed in a shell 311, so as to define a shelf honeycomb. As illustrated in FIG. 2, the pockets 31 contain a dose of substance, solid or liquid, intended to be administered. Said substance can notably be a medicine. The pockets 31 are distributed along two axes, in rows and columns. Each row corresponds for example to a time of taking during a day, each column for example being able to correspond to a distinct day. Each pocket 31 is hermetically sealed, in a manner known per se by a divisible membrane 39. A divisible membrane 39 is designed to be broken and generally has a breaking resistance significantly lower than that of the shell 311. The divisible membrane 39 can be produced of a single piece for all the pockets 31 or each of the pockets 31 can comprise an individualized membrane 39.

The membrane 39 also comprises conductive tracks distributed in rows 36₁ to 36ₘ and conductive tracks distributed in columns 33₁ to 33ₙ. A column conductive track 33 is illustrated for the pocket of FIG. 2. The row and column tracks correspond to respective rows and columns of pockets 31. Thus, the membrane 39 is divided into individual cells 39ᵢⱼ, each cell 39ij being delimited by a row 36i and a column 33j. It is understood from that that the rows 36i and columns 33j are positioned at least partly on the outline of the individual cells, or even that each individual cell 39ij of the membrane is framed or surrounded at least partly by the rows/columns. Each cell of the membrane 39ᵢⱼ also comprises an electrical component 38ᵢⱼ. Each electrical component 38ᵢⱼ is electrically connected between the track of the row 36i and the track of the column 33j delimiting a cell 39ᵢⱼ. In the example illustrated, each cell 39ᵢⱼ is arranged vertically above a pocket 31, the component 38ᵢⱼ that it comprises being formed on a face of the divisible membrane 39 facing the pocket 31. In the examples represented, the components 38ᵢⱼ are identical for each cell 39ᵢⱼ of the membrane.

Each electrical component 38ᵢⱼ and/or its connections to its respective row and/or to its respective column are designed in such a way that, when the membrane 39 is broken, at the cell 39ᵢⱼ, to access the content of the pocket 31, the component 38ᵢⱼ or one of its connections to the row 36i or to the column 33j is sufficiently damaged to break the conduction between the row and the column delimiting said cell, via the component 38ᵢⱼ. However, the operation of opening the membrane at an individual cell 39ᵢⱼ damages neither the adjacent row 36i nor the adjacent column 33j, which remain intact (only the link via the component 38ij is affected by the opening of the membrane at the cell 39ᵢⱼ. To protect the rows 36i and columns 33j, these can advantageously be offset relative to each of the pockets 31, such that the opening of the membrane 39 does not affect these conductive tracks. “Offset” should be understood to mean that the rows 36i and columns 33j do not pass vertically in line with the pockets 31. The components 38ᵢⱼ are offset relative to the rows 36i and columns 33j, such that the corruption of a component 38ᵢⱼ or of its connection to the row 36i and to the column 33j does not induce the corruption of this row 36i and this column 33j. The corruption of a component 38 does not then prevent a detection in the rest of the row 36i and in the rest of the column 33j.

The membrane 39 can also comprise a row of control components 32₁ to 32ₙ. Each control component is connected between, on the one hand, a control track 320 and, on the other hand, a respective column out of the columns 33₁ to 33ₙ. The function of these optional control components will be detailed below.

The membrane 39 and the reading device 2 are independent, so they have an interconnection interface. The membrane 39 thus comprises connection studs 37₁ to 37ₘ, connected to an end of respective row tracks 36₁ to 36ₘ. The connection studs 37₁ to 37ₘ are intended to be electrically connected to respective connection studs 27₁ to 27ₘ of the reading device 2. The membrane 39 also comprises connection studs 34₁ to 34ₙ, connected to an end of respective column tracks 33₁ to 33ₙ. The connection studs 34₁ to 34ₙ are intended to be electrically connected to respective connection studs 24₁ to 24ₙ of the reading device 2. The membrane 39 also comprises a connection stud 32 connected to an end of the control track 320. The connection stud 32 is intended to be electrically connected to a respective connection stud 222 of the reading device 2.

The reading device 2 has, for example, a socket 28 for the insertion of an edge of the package 3, such that the respective studs of the reading device 2 and of the membrane 39 of the package 3 are in contact.

The connection studs 24₁ to 24ₙ of the reading device 2 are connected respectively to a first potential (here a potential Vdd), via resistors, called respective pull-up resistors 23₁ to 23ₙ. Thus, each column 33j is connected to said first potential via a resistor 23ᵢ. These resistors, arranged between a power supply and a measurement point, form, with the components 38ᵢⱼ of the membrane 39, a divider bridge. This makes it possible to measure a voltage, between said components 38ᵢⱼ and the membrane 39, said voltage comprising information concerning the state of the cells (open or closed) of the membrane.

The reading device 2 also has a control and processing circuit 200, for example in the form of a microcontroller. The circuit 200 is connected by a respective measurement input (20₁ to 20ₙ) to an intermediate point between each resistor and its respective connection stud of the socket 28.

The reading device 2 also comprises switches 25₁ to 25ₘ. The switches 25₁ to 25ₘ are suitable for selectively connecting the connection studs 27₁ to 27ₘ to a test point, raised to a second potential (here a ground potential). The circuit 200 also comprises control outputs 21₁ to 21ₘ. Each control output 21₁ to 21ₘ controls a respective switch 27₁ to 27ₘ.

The reading device 2 can also comprise a switch 221. The circuit 200 also comprises an output 22. The output 22 controls the switch 221, so that the connection stud 222 can be connected to said second potential.

When the circuit 200 wants to determine the opening of a cell 39ᵢⱼ of the divisible membrane, on a row i and on a column j, it closes the switch 25ᵢ, such that the row conductive track i is then connected to the second potential, that is to say the ground potential. The column conductive track j is connected to the first potential, that is to say the potential Vdd, via the resistor 23ⱼ. Depending on the damage or not to the component 38ᵢⱼ of the row i and of the column j, or its connections to the row i or column j conductive tracks, the measurement potential Aj, on the measurement input 20ⱼ (connected to the column j conductive track) is different, because of the formation or non-formation of a circuit between the first and second potentials in the reading device 2. Consequently, the circuit 200 is able to determine the absence of conduction by the component 38ᵢⱼ concerned, in order to identify a breaking of its membrane 39 at the cell (i,j). In other words, by measuring the electrical signal at the measurement input 20j, it is possible to determine the state of the cell 39ᵢⱼ. “State of the cell” should be understood to mean a cell that is open or closed. It can thus be considered that the reading device 2 provides electrical power supply via the row tracks, and a reading via the column tracks.

To detect the access to a pocket 31 out of M*N pockets, the membrane 39 requires only M+N conductive tracks. Consequently, a limited number of conductive tracks can be used for a large number of pockets 31, which makes it possible to retain a membrane 39 and a packaging 3 that are compact and relatively inexpensive, and that require a relatively simple reading device 2 at its interfaces. Furthermore, the connector 28 comprises fewer contacts, and can then be more robust.

The electrical components 32₁ to 32ₙ, or control components, connected to the control track 320 advantageously make it possible to identify the columns of the membrane 39 actually connected to the reading device 2. Thus, each column j comprises a control component 32j that makes it possible to link the control track 320 to a stud 24j. These control components 32j are not situated in a cell of the membrane, intended to be broken, but at the periphery of the cells defined on the membrane 39. The control components notably make it possible to detect the absence of one or more columns on the matrix, and to identify the missing column or columns. Thus, when the control track is activated, the measurements performed at each point 24j make it possible to detect the presence or the absence of the column j. The presence of these electrical components is optional.

FIG. 3 schematically illustrates a packaging 3 with a divisible membrane according to a first variant of the invention, in which the electrical components 38 are resistors (like the control components 32₁ to 32ₙ). The switches 25₁ to 25ₘ here selectively connect the connection studs 27₁ to 27ₘ (and therefore the row tracks 36₁ to 36ₘ) to the first potential or to the second potential. In the absence of a test of a cell 39ᵢⱼ delimited at least partly by a row i, the switch 25ᵢ connects the row track i to the first potential (potential Vdd), in order to avoid a circulation of current between a tested row and an untested row when a component 38ᵢⱼ does not ensure the conduction between a row i and a column j, such a circulation potentially masking the effect of the opening of a cell. Thus, the fact that the ends of the untested lines are kept at a potential identical to the first potential, in this case V_{dd}, makes it possible to ensure the reliability of the measurement.

The system 1 using such a membrane 39 of a packaging 3 and such a reading device 2 implements a detection of opening of a pocket 31 via a voltage divider principle illustrated in FIG. 4.

To test a cell arranged on a row i of a membrane 39, the switch 25ᵢ connects the row track i to the second potential. Depending on the damage or not of the resistor 38ᵢⱼ associated with the cell 39ᵢⱼ, or of its connections to the row i or column j conductive tracks, the potential Aj on the measurement input 20ⱼ (connected to the column j conductive track) varies. When the conduction is interrupted, the potential measured on the measurement input 20ⱼcorresponds to the first potential V_{dd}. When the resistor 38 is intact, the potential on the measurement input 20ⱼ takes an intermediate value between the first and second potentials, as detailed hereinbelow. The resistor Req corresponds to the equivalent resistance corresponding to the parallel connection of the pull-up resistor (23j) with the resistors 38ᵢⱼ of the other cells situated on the same column j and the control resistor 32ⱼ of this column j. Aj will be used to denote the potential value measured at the measurement input 20ⱼ, this potential being called measurement potential.

When the resistor 38 does indeed ensure the conduction between the row i and column j tracks, the potential Aj takes the following value:

Aj=Vdd*R38ᵢⱼ/(R38ᵢⱼ+Req)

With Vdd being the value of the first potential and R38ᵢⱼ the value of the resistor 38 associated with the cell 39ᵢⱼ tested.

With 1/Req=(1/R23j)+(1/R32j)+Σ(1/Rj)

With R23j being the resistance of the pull-up 23ⱼ, R32j the control resistor 32ⱼ, and Rj the resistance equivalent to the other resistors 38ᵢⱼ of the cells of the column j, different from the resistance associated with the cell tested. In practice, the tracks 320, and 36₁ to 36ₘ are connected to the first potential, except for the line i tested. The value of the measurement potential Aj therefore depends on the number of resistors 38ᵢⱼ that are still operational in the column j, other than the resistor 38 tested. It is possible to determine whether the resistor 38ᵢⱼ still ensures the conduction between the idle potential and the test potential, by comparing the value of the measurement potential Aj to a threshold.

Tests have been performed with the following values:
a first potential Vdd of 15.3 V;
a second test potential equal to the ground;
resistances R38, R32j, R23j and Rj of 5.6 kΩ);
four resistors 38 in the column j;
a threshold of 13.7 V.

These tests have made it possible to determine that the non-conduction of the resistor 38 tested was a discriminating factor in relation to the selected threshold, the following potentials Aj having been measured in the different cases:
a measurement potential Aj=15.3 V when the resistor 38 is not conducting (which corresponds to the idle potential);
a measurement potential Aj=12.2 V when the resistor 38 is conducting and the other three resistors 38 of the column are also conducting;
a measurement potential of Aj=11.5 V when the resistor 38 is conducting and only two other resistors 38 of the column are also conducting;
a measurement potential Aj=10.2 V when the resistor 38 is conducting and only one other resistor 38 of the column is also conducting;
a measurement potential Aj=7.7 V when the resistor 38 is conducting and none of the other resistors 38 of the column is also conducting.
   Other values for first and second potential, number and values of resistors and/or threshold values can obviously be chosen.

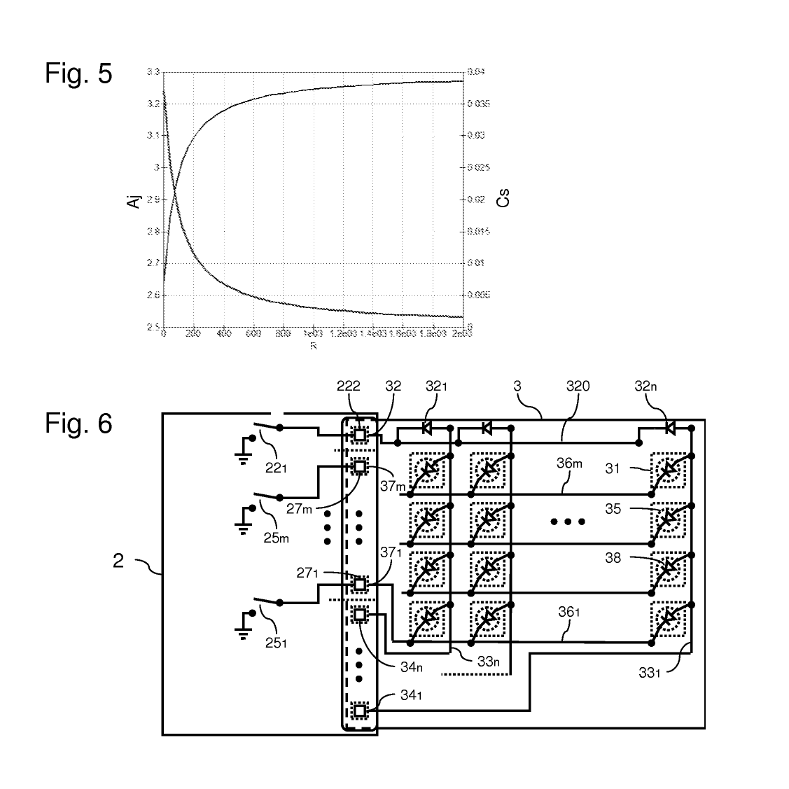

In order to optimize the consumption, it is possible to have, between each switch 22i and the first resistor 38_{i,j=1} of the column j=1, a resistor 40ᵢ, called subsidiary resistor associated with the row i. When a cell 39ᵢⱼ of a row 36i is tested, the switch 22i is connected to the second potential, which allows for a circulation of current in the columns 33j connected to the row 36i via a component 38ᵢⱼ, said columns being connected to the first potential via resistors 23j. The addition of a subsidiary resistor 40i on a row 36i makes it possible to reduce the intensity of the current circulating in the row, as can be seen in FIG. 5.

FIG. 5 is a diagram that makes it possible to determine the value of a subsidiary resistor 40i as a function of the consumption of the circuit and of the measurement dynamic range. In this example, the first potential Vdd is equal to 3.3 V. Each resistor R38ij associated with a row 36i and a column 33j and each pull-up resistor R23j respectively has a value of 500Ω and 20 kΩ. A first curve corresponds to the value of the measurement potential Aj, as a function of the value of the subsidiary resistor 40i, when all the other resistors 38 of the column are operational. This curve is therefore representative of the detection sensitivity by the difference between this value Aj and the value Vdd, the latter being equal to 3.3 V. This curve therefore represents the measurement dynamic range. A second curve corresponds to the intensity of the current circulating in the row tested as a function of the value of the subsidiary resistor 40i. Thus, a trade-off has to be made between a good detection sensitivity and a low current consumption. In this example, a 100Ω resistance makes it possible to obtain a measurement margin of 0.3 V for the measurement potential Aj with a maximum steady-state consumption of 15 mA.

The resistors 38 can be produced by metal deposition of an appropriate form on a film intended to form the membranes 39.

FIG. 6 schematically illustrates a packaging 3 according to a second variant of the invention, in which the electrical components 38 are diodes (like the components 32₁ to 32ₙ). The switches 25₁ to 25ₘ here selectively connect connection studs 27₁ to 27ₘ (and therefore the row tracks 36₁ to 36ₘ) to the second potential (the latter being able to be a fixed or floating potential). In the absence of a test of a cell arranged on the row 36i of the membrane 39, the switch 25; connects the row track i to the floating potential. There is no need to connect the connection studs to the first potential Vdd outside the test phases, the diodes used intrinsically avoiding the circulations of current previously described. The structure of the reading device 2 can thus be simplified.

In the case of a positive power supply potential, the anode of each of the diodes 38 is connected to a respective column track, the cathode of each of these diodes 38 being connected to a respective row track. The anode of each of the diodes 32₁ to 32ₙ is connected to a respective column track, the cathode of each of these diodes being connected to the control track 320.

To test the cells 39ᵢⱼ of a row 36i, the switch 25ᵢ connects the row track i to the second potential, in this case the ground. Depending on the damage or non-damage to the diode 38ᵢⱼ of the row i and of the column j, or its connections to the row i or column j conductive tracks, the measurement potential Aj on the measurement input 20ⱼ (connected to the column j conductive track) is different.

When the connection of the diode 38 to its row and column tracks is interrupted, the potential on the measurement input 20ⱼ corresponds to the first potential Vdd. When the diode 38 is intact, the potential on the measurement input 20ⱼ is equal to the second potential, in this case the ground. The reading of the potential Aj applied to the measurement input 20ⱼ is independent of the state of the other diodes 38 of the column j. Furthermore, the application of the measurement potential Aj to the processing circuit 200 does not require any analogue measurement or comparator circuit to determine the state of the diode 38 tested.

The diodes 38 and 32₁ to 32ₙ can be produced by printing or deposition of semiconductor materials on a film intended to form the membranes 39.

FIG. 7 illustrates an embodiment, whereby pockets 31 of a packaging 3 can be selectively separated or joined. These pockets 31 are intended to be separated in order, if necessary, to present smaller bulk in the event of a displacement, and in order to be able to join them and determine the medicines actually used during this displacement.

Thus, the membrane 39 can be divided into a plurality of elements 30, each element 30 comprising, for example, cells 39ij arranged along one and the same column 33j. The electrical components illustrated here are diodes, but this refinement can also be applied to other electrical components, such as the resistors described previously.

To this end, each element 30 comprises a column track 39j, a portion of the control track 320, and a portion of the row tracks 36₁ to 36ₘ. The portion of control track 320 is connected on the one hand to an output connection stud 32 and to an input connection stud 32′. The portions of row track 36₁ to 36ₘ are connected on the one hand to respective output connection studs 37₁ to 37ₘ and on the other hand to respective input connection studs 37′₁ to 37′ₘ. Each element 30 comprises track portions for the columns of the other elements 30, connected between respective output connection studs 34₁ to 34ₙ and respective input connection studs 34′₁ to 34′ₙ. For an element 30 corresponding to the column j, the column track 33ⱼ is connected to the output connection stud 34ⱼ. The input connection stud 34′ⱼ is not connected to the output connection stud 34ⱼ of this same element 30, in order to avoid producing a detection of two identical columns. The input connection studs and the output connection studs of two elements 30 joined together are thus placed in contact in order to reform the row and column conductive tracks to enable the reading device 2 to test the access to the different pockets 31 connected. It is found that the reading device can identify the element 30 tested, in particular by means of the control track 320. In practice, when the control switch 32 connects the control line 320 to a potential that is different from the potential Vdd, and for example to the ground, a measurement can be made on each measurement point 20j in order to verify the absence or the presence of the cells 39ij belonging to one and the same column 33j. The value of the measurement potential Aj then depends on the presence or the absence of said cells.

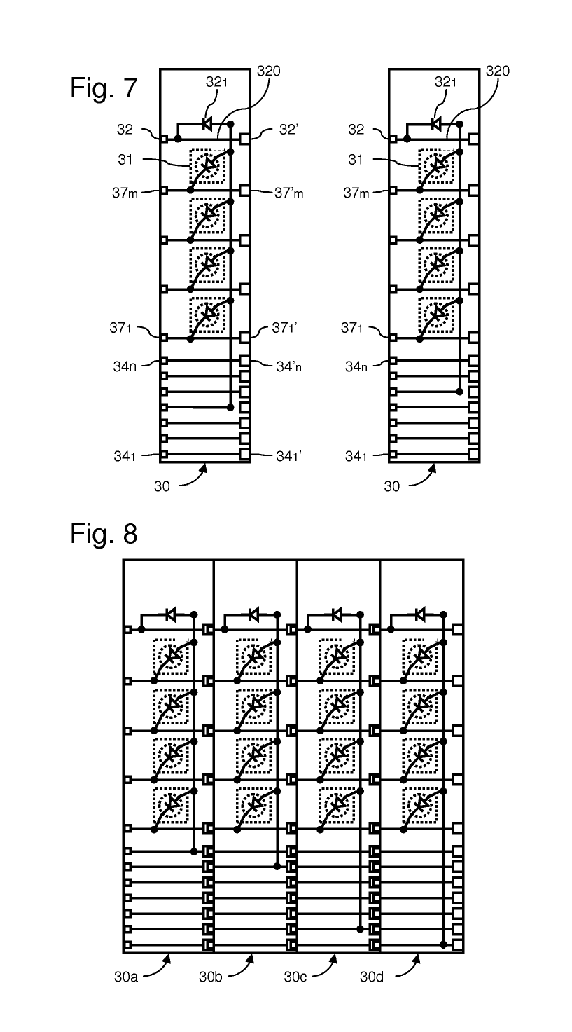

In the example of FIG. 8, only the columns 30a, 30b, 30c and 30d, which are joined together, have been retained. In this example, the third and fifth columns have been removed. The measurement potential Aj is zero when j=3, 4 or 5, which indicates that an element 30, joining the cells of the third and fifth columns, has been removed.

The packaging 3 can take the form of elements 30 initially of a single piece, this packaging 3 being able to be designed to split these elements 30 into different columns. The packaging 3 (like the membrane 39) can, for example, include thinned portions or perforations at the join between two successive elements 30. Male/female connections may be designed in order to fix together the elements 30 that have been split.

The membranes 39 can be fixed on the shell 311 in the form of one and the same film, for example a self-adhesive film on which are formed the conductive tracks and/or the electrical components 38. The conductive tracks and the electrical components 38 can be formed on the internal face of such a film in order to limit their risks of damage.

In order to guarantee that the connection of the electrical component to a row or column track is indeed broken vertically above a pocket 31, it is possible for example to provide for this connection to extend linearly over most of the membrane 39 vertically above a pocket 31, such that any breaking of the membrane 39 culminates in a breaking of this linear connection.

On the other hand, to protect the row and column tracks from an electrical component when the breaking of this electrical component 38 which connects them occurs, these row and column tracks are advantageously offset relative to each pocket 31 and relative to this electrical component 38.

The reading device 2 can advantageously have different communication functions. The reading device 2 may, for example, have a time reference and store time bands for access to the pockets 31. The reading device 2 may, for example, warn the patient of the need to take his or her medicines during a given time band, or warn the medical personnel of a failure to take medicines or of medicines taken from an incorrect pocket.

1. A divisible membrane, comprising:
a plurality of row conductive tracks distributed in rows;
a plurality of column conductive tracks distributed in columns;
individual cells, the outline of each cell being at least partly delimited by one of said row tracks and one of said column tracks, each individual cell comprising an electrical component, electrically connected between a row conductive track of a respective row and a column conductive track of a respective column.

2. The membrane according to claim 1 in which said individual cells are divisible.

3. The membrane according to claim 2, wherein said conductive tracks and said electrical components are formed on the same film.

4. The membrane according to claim 1, in which each electrical component is offset relative to the row conductive track of its respective row and relative to the column conductive track of its respective column.

5. A system comprising a membrane according to claim 1 and a reading device, comprising a control and processing circuit suitable for:
connecting each column conductive track to a first potential;
selectively connecting a row conductive track (36j) to a second potential different from the first potential;
determining the absence of electrical conduction between a given row conductive track and a given column conductive track, when the given row conductive track is connected to the second potential;
identifying a breaking of a cell on the row and the column corresponding to the determined absence of electrical conduction.

6. The system according to claim 5, in which the first potential is greater than the second potential, and in which said electrical components are diodes whose anode is connected to the first potential and whose cathode is connected selectively to the second potential.

7. The system according to claim 5, in which said electrical components are resistors.

8. The system according to claim 7, in which said reading device comprises switches selectively connecting respective row conductive tracks to the first potential or to the second potential, said control and processing circuit being configured to simultaneously connect only one of said row conductive tracks to said second potential.

9. The system according to claim 5, in which the membrane can be split into distinct column elements, said column elements each having a portion of said row conducive tracks and being configured to be joined so as to form said row conductive tracks and said column conductive tracks.

10. The system according to claim 5, in which the membrane also comprises a control conductive track which comprises control electrical components connected between the control conductive track and respective column conductive tracks, said control and processing circuit being configured to selectively connect said control track to the second potential.

11. The system according to claim 5, in which said reading device comprises an interface connecting the column conductive tracks to a first potential and comprise connection studs connected to respective column conductive tracks, the reading device further comprising pull-up resistors connected to respective connection studs, said control and processing circuit being configured to measure the voltage between a pull-up resistor and a respective connection stud in order to determine said absence of electrical conduction.

12. The system according to claim 8, in which said control and processing circuit comprises a comparator for comparing said measured voltage to a reference threshold to determine said absence of electrical conduction.

13. The system according to claims 5, in which the membrane and the reading device are configured to be selectively one of interconnected and separated.

14. The system according to claim 5, comprising a matrix of pockets distributed along said rows and said columns, each of said pockets being sealed by the membrane and being arranged under a respective individual cell.

15. The system according to claim 14, in which said row conductive tracks and said column conductive tracks are offset relative to said pockets.
